(19) United States
(12) Patent Application Publication
(10) Pub. No.: US 2025/0205106 A1
(43) Pub. Date: Jun. 26, 2025

(54) HEAD MASSAGING APPARATUS

(71) Applicant: Jon Ewing, Shawnee, OK (US)

(72) Inventor: Jon Ewing, Shawnee, OK (US)

(21) Appl. No.: 18/392,940

(22) Filed: Dec. 21, 2023

(51) Int. Cl. A61H 7/00

(52) U.S. Cl. CPC A61H 7/006; A61H 2201/1607; A61H 2201/501; A61H 2201/5048; A61H 2205/02

(57) ABSTRACT

A head massaging apparatus for massaging a user's head includes a base shaped and configured to extend around a back side of a head of a user. A plurality of massager assemblies is coupled to the base. The massager assemblies are distributed between a pair of ends of the base. Each massager assembly comprises an arm, a plurality of massager heads, and a drive mechanism. The arm is coupled to and extends away from the base. The arm extends arcuately forward from the base and is shaped and configured to extend around the head of the user. The plurality of massager heads is mounted to an inner side of the arm, and each massager head is rotatable with respect to the arm. The drive mechanism is operatively coupled to the plurality of massager heads. A processor is operatively coupled to the drive mechanisms of the plurality of massager assemblies.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to head massagers and more particularly pertains to a new head massager for massaging a user's head.

### (2) Description of Related Art Including Information Disclosed Under 37 CFR 1.97 and 1.98

Various head massagers are available to be worn on a user's head and operated to massage the head. However, the prior art fails to describe such an apparatus which uses a plurality of spaced apart arms that extend over the user's head when worn and which have massager heads attached to them such that the massager heads may be rotated to massage the user's head. The prior art also fails to disclose such an apparatus that is configured to play audio via headphones for the user while the massager heads massage the head.

### BRIEF SUMMARY OF THE INVENTION

An embodiment of the disclosure meets the needs presented above by generally comprising a base shaped and configured to extend around a back side of a head of a user. A plurality of massager assemblies is coupled to the base. The massager assemblies are distributed between a pair of ends of the base. Each massager assembly comprises an arm, a plurality of massager heads, and a drive mechanism. The arm is coupled to and extends away from the base. The arm extends arcuately forward from the base and is shaped and configured to extend around the head of the user. The plurality of massager heads is mounted to an inner side of the arm, and each massager head is rotatable with respect to the arm. The drive mechanism is operatively coupled to the plurality of massager heads. A processor is mounted in the base and is operatively coupled to the drive mechanisms of the plurality of massager assemblies.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom rear perspective view of a head massaging apparatus according to an embodiment of the disclosure.

FIG. 2 is a bottom front perspective view of an embodiment of the disclosure.

FIG. 3 is a bottom view of an embodiment of the disclosure.

FIG. 4 is a side view of an embodiment of the disclosure.

FIG. 5 is a rear view of an embodiment of the disclosure.

FIG. 6 is a top view of an embodiment of the disclosure.

FIG. 7 is a partial top view of an embodiment of the disclosure.

FIG. 8 is a cross-section view of an embodiment of the disclosure taken from Arrows 8-8 in FIG. 4.

FIG. 9 is an exploded detail view of a massager head and an arm of a massager assembly of an embodiment of the disclosure.

FIG. 10 is an in-use view of an embodiment of the disclosure.

FIG. 11 is a block diagram of an embodiment of the disclosure.

### DETAILED DESCRIPTION OF THE INVENTION

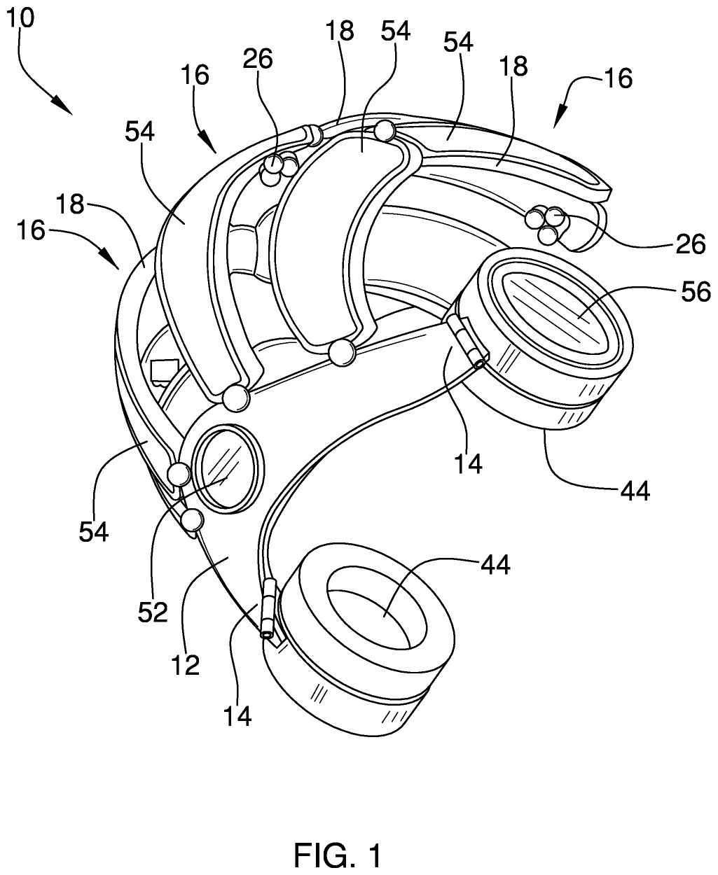

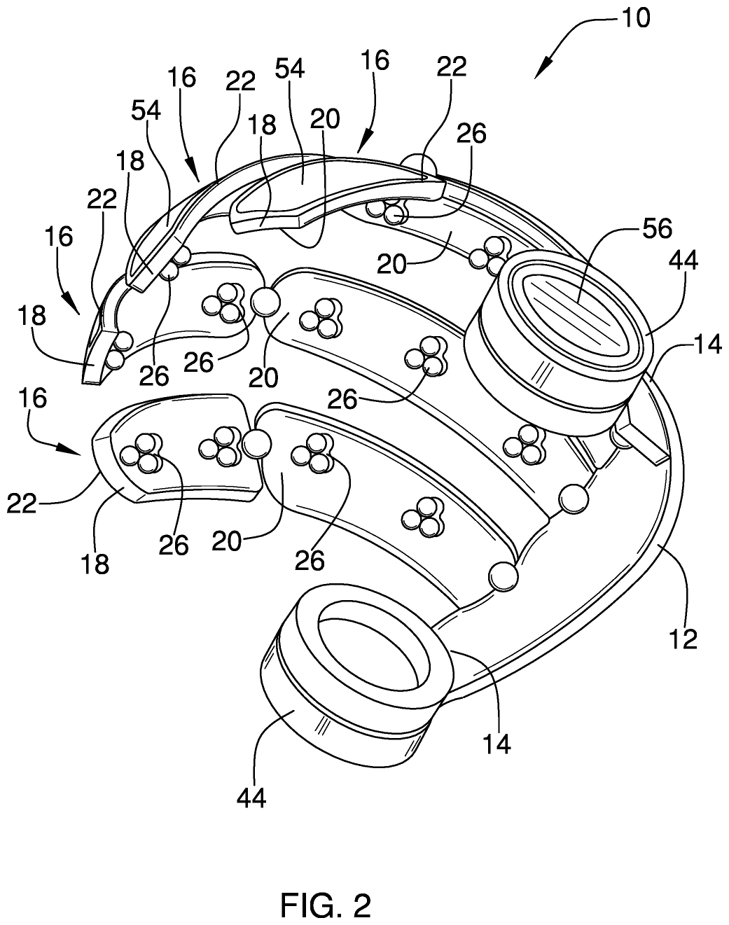

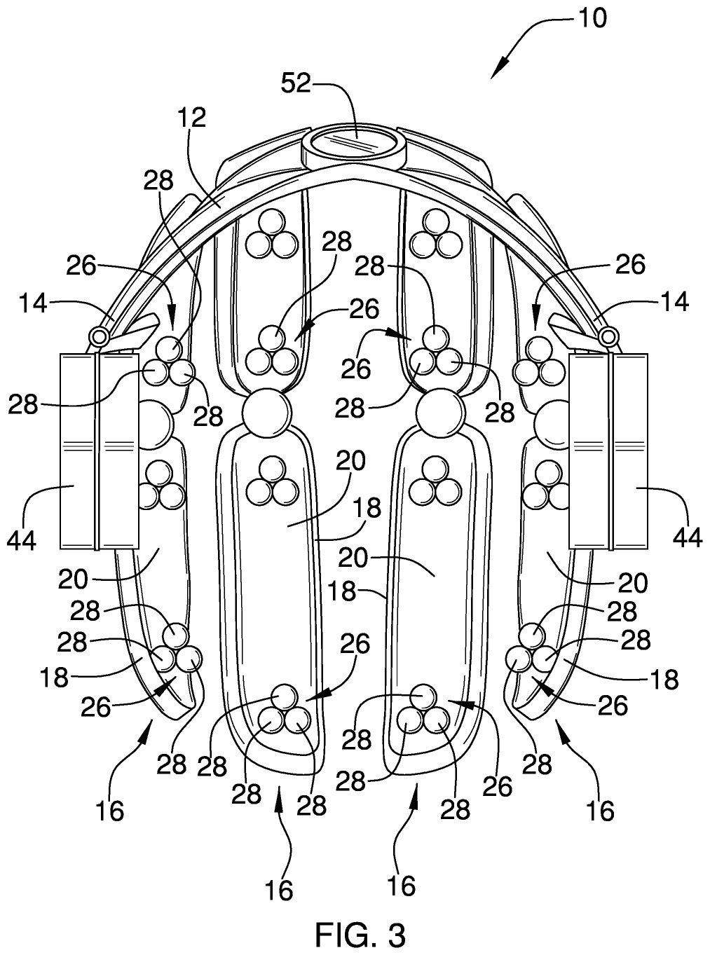

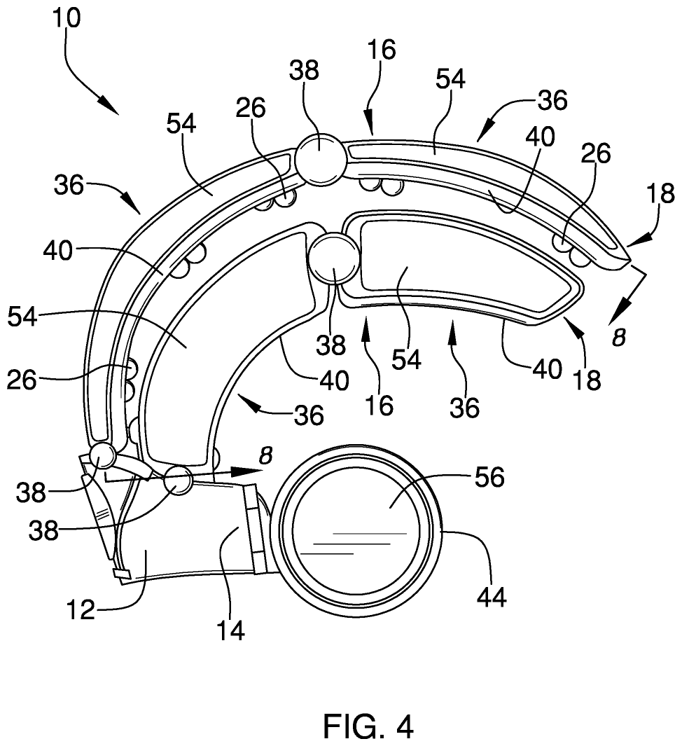

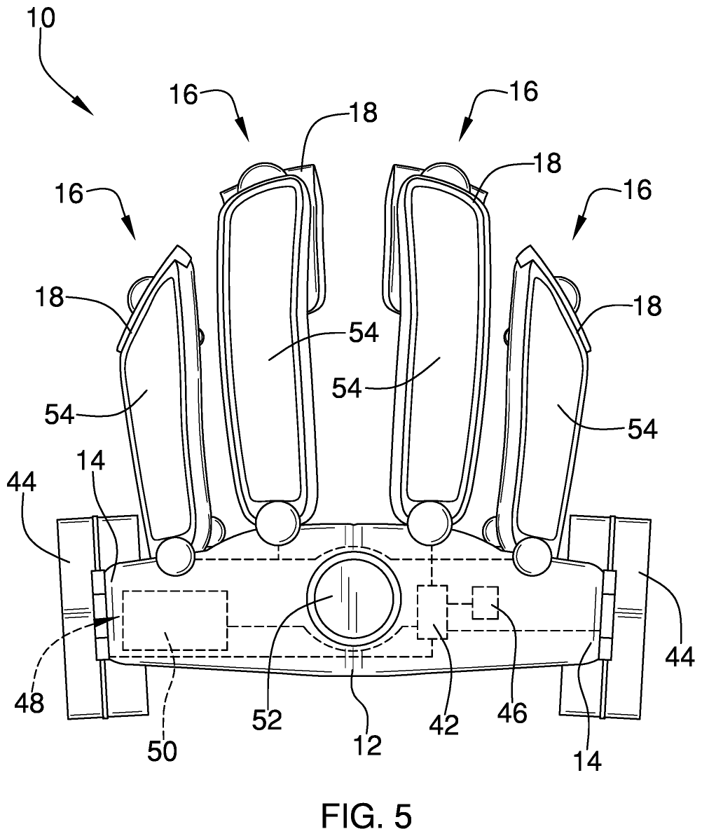

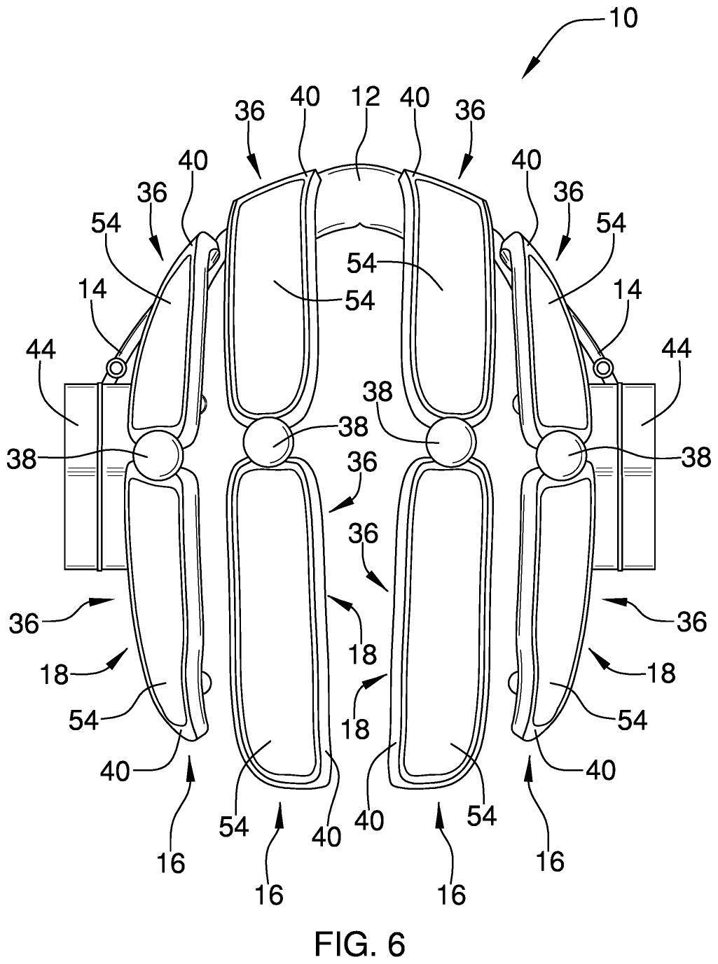

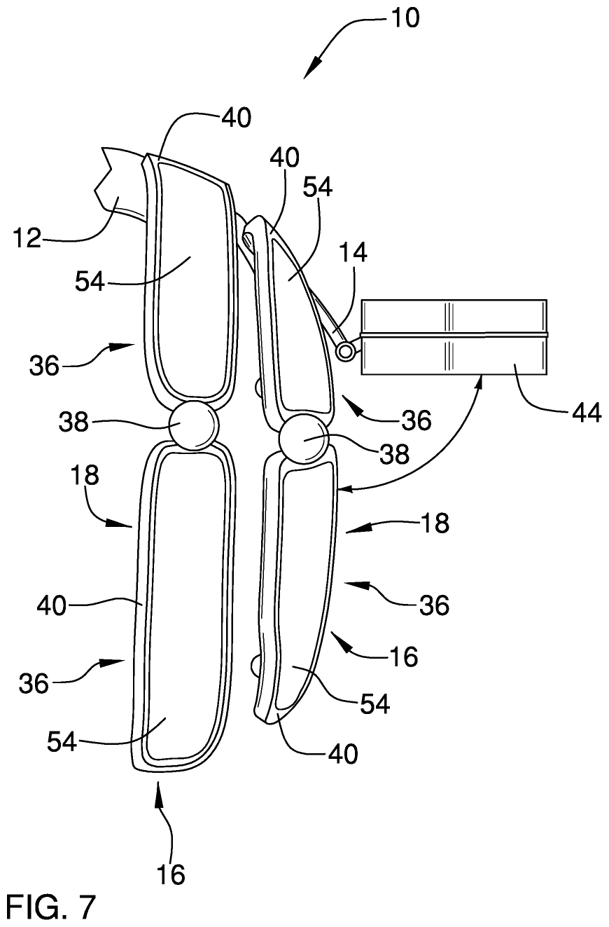

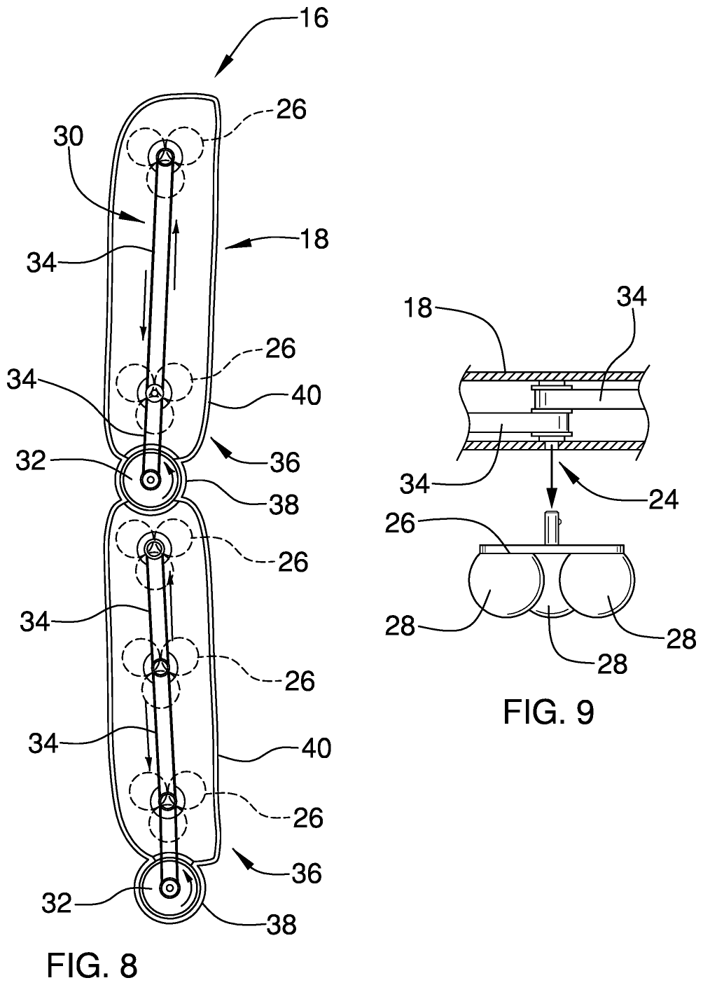

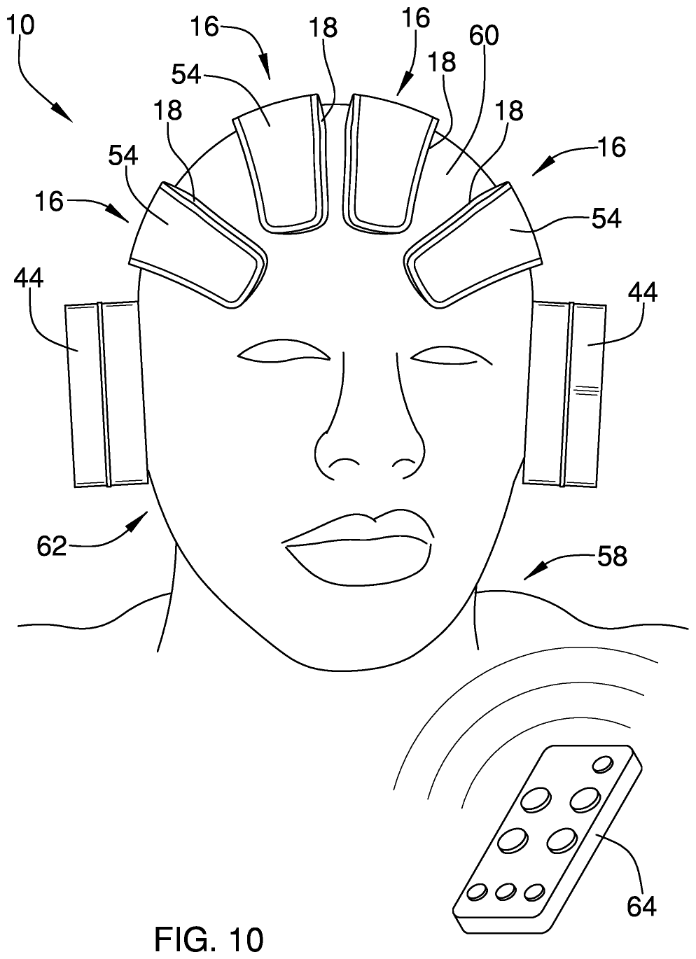

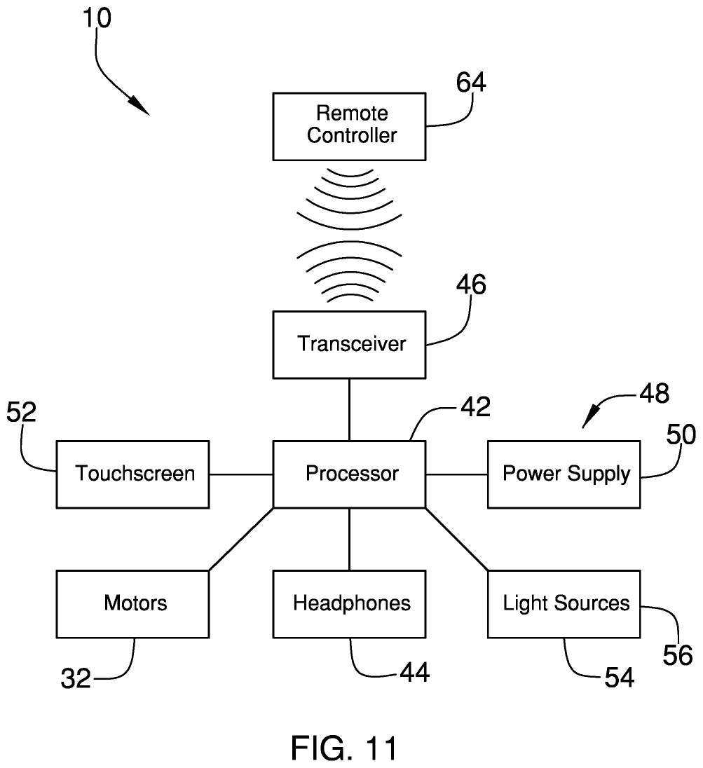

With reference now to the drawings, and in particular to FIGS. 1 through 11 thereof, a new head massager embodying the principles and concepts of an embodiment of the disclosure and generally designated by the reference numeral 10 will be described.

As best illustrated in FIGS. 1 through 11, the head massaging apparatus 10 generally comprises a base 12 shaped and configured to extend around a back side 62 of a head 60 of a user 58. A plurality of massager assemblies 16 is coupled to the base 12. The massager assemblies 16 are distributed between a pair of ends 14 of the base 12, and each massager assembly 16 comprises an arm 18, a plurality of massager heads 26, and a drive mechanism 30. The arm 18 is coupled to and extends away from the base 12. The arm 18 extends arcuately forward from the base 12 and is shaped and configured to extend around the head 60 of the user 58. The plurality of massager heads 26 is mounted to an inner side 20 of the arm 18. Each massager head 26 of the plurality of massager heads 26 is removable from the arm 18. The plurality of massager heads 26 may be interchangeably mounted in sockets 24 in the arm 18, and other head engagement members may be alternately mounted in the sockets 24. For example, other massaging elements, hair-brushing elements, or other head or hair treatment elements may be placed in the sockets 24 and operated via the drive mechanism 30.

Each massager head 26 of the plurality of massager heads 26 is rotatable with respect to the arm 18 when placed in one of the sockets 24. Each massager head 26 comprises a plurality of spherical protrusions 28 which are radially arranged around a rotational axis of the massager head 26. The drive mechanism 30 is operatively coupled to the plurality of massager heads 26. The drive mechanism 30 comprises a pair of motors 32, each of which is operatively coupled to an associated subset of the plurality of massager heads 26. The drive mechanism 30 comprises a plurality of belts 34 which couple each motor 32 of the pair of motors 32 to the associated subset of the plurality of massager heads 26. In other embodiments, one motor 32 may be used in each massager mechanism, or other suitable drive mechanisms 30 may be used.

The arm 18 comprises a pair of modules 36, each of which comprises a housing 38 which houses an associated motor 32 of the pair of motors 32 and a massager mount 40 to which an associated subset of the plurality of massager heads 26 is mounted. The associated motor 32 of each module 36 is operatively coupled to the associated subset of the plurality of massager heads 26 of each module 36. A processor 42 is mounted in the base 12 and is operatively coupled to the drive mechanisms 30 of the plurality of massager assemblies 16.

A pair of headphones 44 is mounted to the base 12. Each headphone 44 is positioned at an associated one of the pair of ends 14 of the base 12, and the pair of headphones 44 is operably coupled to the processor 42. The headphones 44 are pivotable toward and away from each other. A transceiver 46 is mounted in the base 12 and is operably coupled to the processor 42 wherein the processor 42 is configured to communicate with a remote controller 64 via the transceiver 46. The processor 42 is configured to receive commands from the remote controller 64 for operating the processor 42. The remote controller 64 may be a smartphone, a computer, or the like in some cases. The processor 42 may also be configured to receive audio from the remote controller 64 via the transceiver 46 and to play the audio using the headphones 44. Or the processor 42 may have a memory on which audio is stored which may be played via the headphones 44.

A power supply 48 is mounted in the base 12 and is electrically coupled to the processor 42. The power supply 48 comprises a battery 50 but may comprise a capacitor or other suitable power storage. A touchscreen 52 is mounted on the base 12 and is operatively coupled to the processor 42. The touchscreen 52 may be used to input commands to the processor 42. Other input devices may be used to input commands to the processor 42. A plurality of light displays is operatively coupled to the processor 42. The plurality of light displays includes a plurality of arm light displays 54 and a plurality of headphone light displays 56. Each arm light display 54 is mounted on an outer side 22 of the arm 18 of an associated massager assembly 16 of the plurality of massager assemblies 16, and each headphone light display 56 is mounted on an associated headphone 44 of the pair of headphones 44. The processor 42 may be programmed to selectively cause the plurality of light displays 54 to display selected light patterns for aesthetic or utilitarian purposes.

In use, the head massaging apparatus 10 is worn on the user's 58 head 60. The processor 42 may be operated to cause the drive mechanisms 30 of the plurality of massager assemblies 16 to rotate the massager heads 26, thereby massaging the user's 58 head 60. The processor 42 may be operated by the remote controller 64, the touchscreen 52, or another input device. Audio may be played via the headphones 44 by operation of the processor 42 as well. The massager heads 26 may be removed and replaced with other massager heads 26 or other head or hair treatment elements.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A head massaging apparatus comprising:
a base shaped and configured to extend around a back side of a head of a user;
a plurality of massager assemblies coupled to the base, the plurality of massager assemblies being distributed between a pair of ends of the base, each massager assembly comprising:
an arm coupled to and extending away from the base, the arm extending arcuately forward from the base, the arm being shaped and configured to extend around the head of the user;
a plurality of massager heads mounted to an inner side of the arm, each massager head of the plurality of massager heads being rotatable with respect to the arm; and
a drive mechanism operatively coupled to the plurality of massager heads; and
a processor mounted in the base and operatively coupled to the drive mechanisms of the plurality of massager assemblies.

2. The apparatus of claim 1, wherein each massager head of the plurality of massager heads of each massager assembly is removable from the arm of the massager assembly.

3. The apparatus of claim 1, wherein each massager head comprises a plurality of spherical protrusions which are radially arranged around a rotational axis of the massager head.

4. The apparatus of claim 1, wherein the drive mechanism of each massager assembly comprises a pair of motors, each motor of the pair of motors being operatively coupled to an associated subset of the plurality of massager heads.

5. The apparatus of claim 4, wherein the drive mechanism of each massager assembly comprises a plurality of belts which couple each motor of the pair of motors to the associated subset of the plurality of massager heads.

6. The apparatus of claim 4, wherein the arm of each massager assembly comprises a pair of modules, each module of the pair of modules comprising a housing which houses an associated motor of the pair of motors and a massager mount to which an associated subset of the plurality of massager heads is mounted, the associated motor of each module being operatively coupled to the associated subset of the plurality of massager heads of each module.

7. The apparatus of claim 1, further comprising a pair of headphones mounted to the base, each headphone being positioned at an associated one of the pair of ends of the base, the pair of headphones being operably coupled to the processor.

8. The apparatus of claim 7, wherein the headphones of the pair of headphones are pivotable toward and away from each other.

9. The apparatus of claim 1, further comprising a transceiver operably coupled to the processor wherein the processor is configured to communicate with a remote controller via the transceiver, the processor being configured to receive commands from the remote controller.

10. The apparatus of claim 1, further comprising a power supply mounted in the base and electrically coupled to the processor.

11. The apparatus of claim 10, wherein the power supply comprises a battery.

12. The apparatus of claim 1, further comprising a touchscreen mounted on the base and operatively coupled to the processor.

13. The apparatus of claim 1, further comprising a plurality of light displays operatively coupled to the processor, the plurality of light displays including a plurality of arm light displays and a plurality of headphone light displays, each arm light display being mounted on an outer side of the arm of an associated massager assembly of the plurality of massager assemblies, each headphone light display being mounted on an associated headphone of the pair of headphones.

14. A head massaging apparatus comprising:
a base shaped and configured to extend around a back side of a head of a user;
a plurality of massager assemblies coupled to the base, the plurality of massager assemblies being distributed between a pair of ends of the base, each massager assembly comprising:
an arm coupled to and extending away from the base, the arm extending arcuately forward from the base, the arm being shaped and configured to extend around the head of the user;
a plurality of massager heads mounted to an inner side of the arm, each massager head of the plurality of massager heads being removable from the arm, each massager head of the plurality of massager heads being rotatable with respect to the arm, each massager head comprising a plurality of spherical protrusions which are radially arranged around a rotational axis of the massager head; and
a drive mechanism operatively coupled to the plurality of massager heads, the drive mechanism comprising a pair of motors, each motor of the pair of motors being operatively coupled to an associated subset of the plurality of massager heads, the drive mechanism comprising a plurality of belts which couple each motor of the pair of motors to the associated subset of the plurality of massager heads;
wherein the arm comprises a pair of modules, each module of the pair of modules comprising a housing which houses an associated motor of the pair of motors and a massager mount to which an associated subset of the plurality of massager heads is mounted, the associated motor of each module being operatively coupled to the associated subset of the plurality of massager heads of each module;
a processor mounted in the base and operatively coupled to the drive mechanisms of the plurality of massager assemblies;
a pair of headphones mounted to the base, each headphone being positioned at an associated one of the pair of ends of the base, the pair of headphones being operably coupled to the processor, the pair of headphones being pivotable toward and away from each other;
a transceiver mounted in the base and operably coupled to the processor wherein the processor is configured to communicate with a remote controller via the transceiver, the processor being configured to receive commands from the remote controller;
a power supply mounted in the base and electrically coupled to the processor, the power supply comprising a battery;
a touchscreen mounted on the base and operatively coupled to the processor; and
a plurality of light displays operatively coupled to the processor, the plurality of light displays including a plurality of arm light displays and a plurality of headphone light displays, each arm light display being mounted on an outer side of the arm of an associated massager assembly of the plurality of massager assemblies, each headphone light display being mounted on an associated headphone of the pair of headphones.
